(19) United States
(12) Patent Application Publication
(10) Pub. No.: US 2021/0150582 A1
(43) Pub. Date: May 20, 2021

(54) SYSTEM AND METHOD FOR DETECTING AND RECTIFYING ABNORMAL AD SPENDS

(71) Applicant: Walmart Apollo, LLC, Bentonville, AR (US)

(72) Inventors: Lu Wang, Cupertino, CA (US); Boning Zhang, Santa Clara, CA (US)

(73) Assignee: Walmart Apollo, LLC, Bentonville, AR (US)

(21) Appl. No.: 17/160,337

(22) Filed: Jan. 27, 2021

Related U.S. Application Data
(63) Continuation-in-part of application No. 16/262,485, filed on Jan. 30, 2019.

(51) Int. Cl. G06Q 30/02; G06F 16/95

(52) U.S. Cl. CPC G06Q 30/0273; G06F 16/95; G06Q 30/0246

(57) ABSTRACT

A method including receiving, through a computer network from a search engine, traffic data associated with one or more products, in a time period of a budget period. The method further can include determining an ad-spend amount based at least in part on the traffic data. The method also can include determining a normal range of ad spends for the time period based on a predetermined total allocation amount for the one or more products for the budget period, one or more allocation balancing rules, and/or a spending pattern model. After the normal range is determined, the method further can include detecting an ad-spend anomaly in the time period by monitoring whether the ad-spend amount is outside the normal range. The method additionally can include determining a pacing-control finding that no pacing-control job is being executed. The method further can include transmitting, in real-time through the computer network, an alert to a user in response to the ad-spend anomaly and the pacing-control finding. Other embodiments are disclosed.

### CROSS-REFERENCE TO RELATED APPLICATIONS

This application is a continuation-in-part of U.S. patent application Ser. No. 16/262,485, filed Jan. 30, 2019. U.S. patent application Ser. No. 16/262,485 is incorporated by reference herein in its entirety.

### TECHNICAL FIELD

This disclosure relates generally to a system and/or method for bidding for search engine marketing.

### BACKGROUND

Search engine marketing (SEM) involves promoting websites in search engine results, often through paid advertising to search engine companies. Types of advertisements in SEM can include product listing advertisements and keyword (textual) advertisements, for example. SEM has become a significant factor in driving web traffic to various websites. Allocating resources for SEM can involve many decisions and tradeoffs, and it can be challenging to control for allocation and performance objectives. Further, when abnormal web traffic data from a search engine cause anomalies in advertising spending, the SEM performance can be compromised, and it thus can be desired to have a system and/or method for automatically and timely detecting and rectifying the issues.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a performance bidding system that can be employed for providing a bidding platform with controls for multiple objectives, according to an embodiment;

FIG. 4 illustrates a flow chart for a method, according to an embodiment;

FIG. 5 illustrates an exemplary user interface display to allow a user to provide input to the performance bidding system of FIG. 3 to display output to the user;

FIG. 6 illustrates an exemplary user interface display to allow a user to view performance results using the performance bidding system of FIG. 3;

FIG. 7 shows a graph of an ad spend versus revenue curve at a super department level;

FIG. 8 illustrates a block diagram of a system that can be employed for detecting and rectifying abnormal ad spends;

FIG. 9 illustrates a flow chart for a method for detecting and rectifying abnormal ad spends, according to an embodiment;

FIG. 10 shows a graph of a date versus accumulated ad spend for a division;

FIG. 11 shows a graph of a day of week versus ad spend deviation from average daily ad spend in a week for a division;

FIG. 12 shows a graph of an hour versus ad spend percentage of total daily ad spend in a day for a division; and

FIG. 13 shows a graph of a time versus ad-spend range with actual ad spends as dots on the graph.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, five minutes, ten minutes, or fifteen minutes.

### DESCRIPTION OF EXAMPLES OF EMBODIMENTS

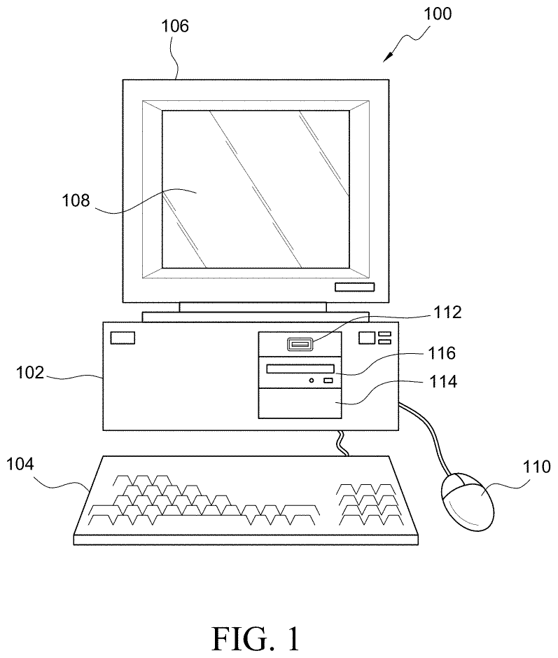

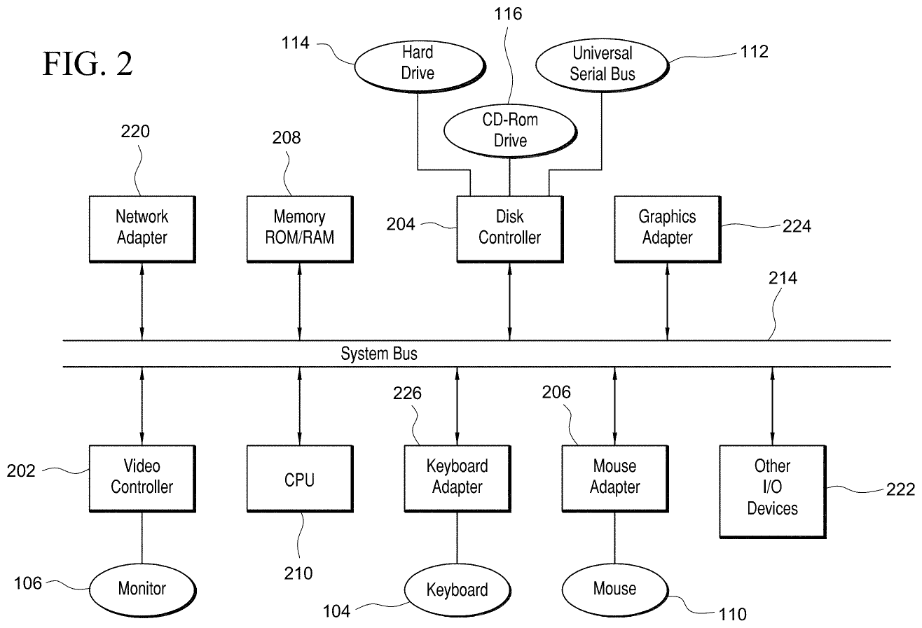

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can includes one or more of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

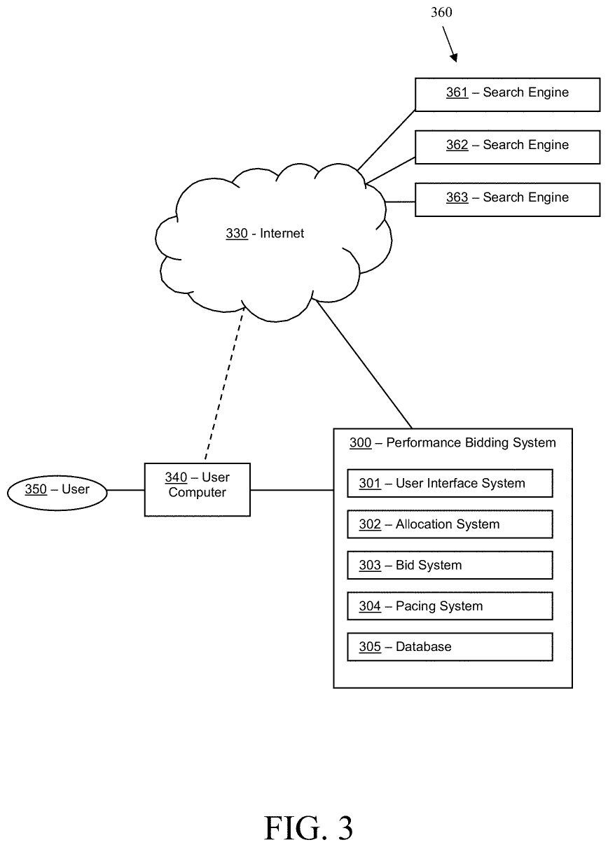

Turning ahead in the drawings, FIG. 3 illustrates a block diagram of a performance bidding system 300 that can be employed for providing a bidding platform with controls for multiple objectives, according to an embodiment. Performance bidding system 300 is merely exemplary and embodiments of the system are not limited to the embodiments presented herein. The system can be employed in many different embodiments or examples not specifically depicted or described herein. In some embodiments, certain elements, modules, or systems of performance bidding system 300 can perform various procedures, processes, and/or activities. In other embodiments, the procedures, processes, and/or activities can be performed by other suitable elements, modules, or systems of performance bidding system 300. Performance bidding system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of performance bidding system 300 described herein.

In many embodiments, performance bidding system 300 can include a user allocation system 301, an allocation system 302, a bid system 303, a pacing system 304, and/or a database 305. In many embodiments, the systems of performance bidding system 300 can be modules of computing instructions (e.g., software modules) stored at non-transitory computer readable media that operate on one or more processors. In other embodiments, the systems of performance bidding system 300 can be implemented in hardware. Performance bidding system 300 can be a computer system, such as computer system 100 (FIG. 1), as described above, and can be a single computer, a single server, or a cluster or collection of computers or servers, or a cloud of computers or servers. In another embodiment, a single computer system can host performance bidding system 300. Additional details regarding performance bidding system 300 and the components thereof are described herein.

In some embodiments, performance bidding system 300 can be in data communication directly or through Internet 330 with one or more user computers, such as user computer 340. In some embodiments, user computer 340 can be used by users, such as user 350. In many embodiments, performance bidding system 300 can host a website, an application, or another form of graphical user interface. For example, performance bidding system 300 can host a website that allows users, such as business managers or marketing managers, to manage bidding for SEM. In many embodiments, an internal network that is not open to the public can be used for communications between performance bidding system 300 and user computer 340. In other embodiments, user computer 340 can access performance bidding system 300 through Internet 330.

In certain embodiments, user computers (e.g., 340) can be desktop computers, laptop computers, a mobile device, and/or other endpoint devices used by users (e.g., 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In specific examples, a wearable user computer device can include a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can include (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can include the Virtual Retinal Display™ product, or similar product by the University of Washington of Seattle, Wash., United States of America. Meanwhile, in further specific examples, a limb mountable wearable user computer device can include the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In many embodiments, performance bidding system 300 can include one or more input devices (e.g., one or more keyboards, one or more keypads, one or more pointing devices such as a computer mouse or computer mice, one or more touchscreen displays, a microphone, etc.), and/or can include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to performance bidding system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of performance bidding system 300. In a similar manner, the processors and/or the non-transitory computer-readable media can be local and/or remote to each other.

Meanwhile, in many embodiments, performance bidding system 300 also can be configured to communicate with and/or include one or more databases, such database 305, and/or other suitable databases. The one or more databases can include a product database that contains information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between performance bidding system 300 the one or more databases can be implemented using any suitable manner of wired and/or wireless communication. Accordingly, performance bidding system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In several embodiments, performance bidding system 300 can be in data communication through Internet 330 with search engines 360, which can include search engine 361-363, for example. For example, search engine 361 can be the Google search engine, search engine 362 can be the Yahoo search engine, and search engine 363 can be the Bing search engine. In many embodiments, search engines 360 each can search SEM services, such as product listing advertisements and/or keyword (e.g., text) advertisements (branded and non-branded). These advertisements can be displayed along with or as part of search results provided by search engines 360 to users of search engines 360. In many embodiments, these advertisements can be used to drive web traffic to a website, such as an e-commerce website. SEM has become a major marketing vehicle for many retailers. For example, a retailer can have more than 67 million products listing advertisements and 90 million keyword advertisements on the Google, Bing, Yahoo search engines (e.g., 361-363), which can create 550 million possible impression opportunities per day.

Budget allocation can be an aspect of SEM business financial planning. In some conventional approaches, a portfolio approach has been used to manage budget. For example, a total budget was set at the beginning of a month for all divisions and the actual advertising spending (“ad spend”) was verified by the end of a month. Under such an approach, there can be a lack of guidelines for budget allocation among each division and subdivision (e.g., super department). In some approaches, a key performance indicator (KPI) can be applied to the overall budget to assess performance.

In several embodiments, performance bidding system 300 can allow a user (e.g., 350), such as a marketing manager, to set a budget allocation amount (e.g., ad spend) at a division or subdivision (e.g., super department, department, or category) level. In a number of embodiments, performance bidding system 300 can provide the user (e.g., 350) with a forecast on how the ad spend specified will impact performance over time, based on KPIs or other performance indicators. In some embodiments, performance bidding system 300 can allocate the budget based on the KPI specified from the user (e.g., 350). For example, the budget can be allocated on a 7-day rolling model, a 14-day rolling model, or on another suitable time frame.

In many embodiments, forecasts of how the ad spend specified will impact performance over time can assist users (e.g., 350), such as business partners, when they perform a budget plan. For example, the forecasts can provide guidance of how much budget to allocate in certain divisions or subdivisions in order to achieve a certain KPI. For example, a business partner can have a budget of $200,000 for the Fashion division for the next 7 days and can desire a performance output of 5.0 for return on ad spend (ROAS). The budget can be entered into performance bidding system 300, and a ROAS range of 3.06 to 4.14 can be displayed, indicating that a ROAS of 5.0 would exceed the forecast for that budget. Accordingly, the amount of budget allocated to Fashion can be decreased in order to meet the ROAS goal of 5.0.

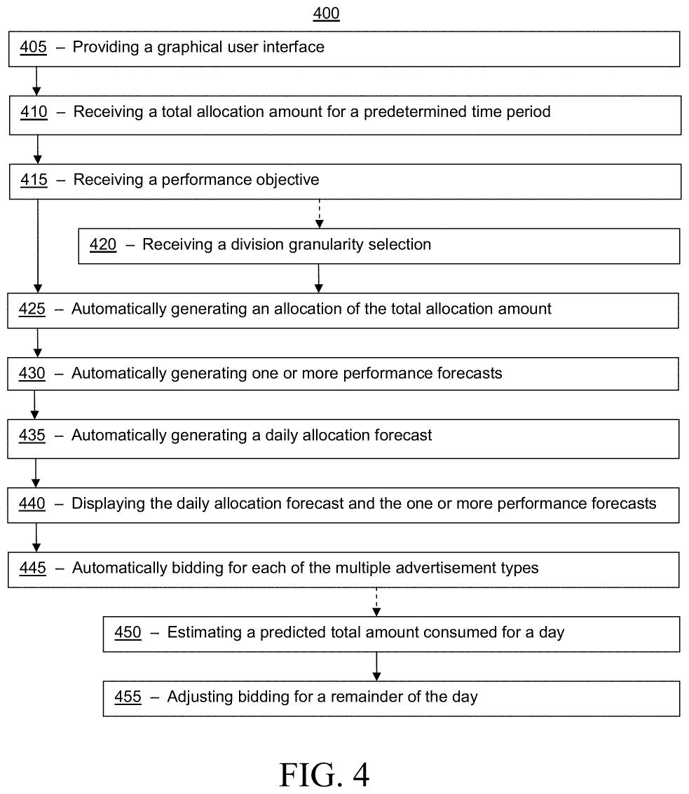

Turning ahead in the drawings, FIG. 4 illustrates a flow chart for a method 400. In some embodiments, method 400 can be a method of providing a bidding platform with controls for multiple objectives. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, performance bidding system 300 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as performance bidding system 300 (FIG. 3). The processor(s) can be similar or identical to the processor(s) described above with respect to computer system 100 (FIG. 1).

In some embodiments, method 400 and other blocks in method 400 can include using a distributed network including distributed memory architecture to perform the associated activity. This distributed architecture can reduce the impact on the network and system resources to reduce congestion in bottlenecks while still allowing data to be accessible from a central location.

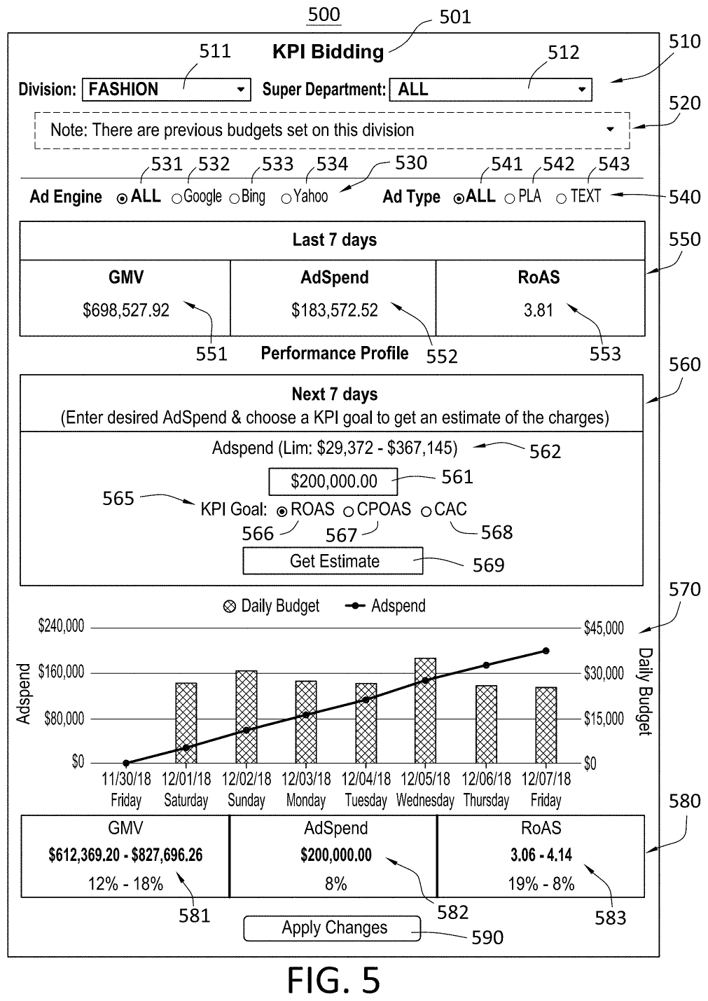

Referring to FIG. 4, method 400 can include a block 405 of providing a graphical user interface comprising input fields and output fields. In many embodiments, the graphical user interface can be similar or identical to user interface display 500, as shown in FIG. 5 and described below.

Turning ahead in the drawings, FIG. 5 illustrates an exemplary user interface display 500 to allow a user (e.g., 350 (FIG. 3)) to provide input to performance bidding system 300 (FIG. 3) to display output to the user. User interface display 500 is merely exemplary, and embodiments of the user interface display are not limited to the embodiments presented herein. The user interface display can be employed in many different embodiments or examples not specifically depicted or described herein, and can include other suitable elements. In many embodiments, performance bidding system 300 (FIG. 3) can provide an interface on user computer 340 (FIG. 3), and the interface can display user interface display 500.

In a number of embodiments, user interface display 500 can include a title bar 501, division granularity input fields 510, a previous allocation information field 520, search engine selection fields 530, ad type selection fields 540, previous week information display fields 550, next week input fields 560, daily allocation forecast display 570, performance forecast display fields 580, apply button 590, and/or other suitable fields or elements. In many embodiments, title bar 501 can indicate include the name of the user interface or portion thereof.

In several embodiments, division granularity input fields 510 can include a division selection field 511, a super department selection field 512, and/or other suitable selection fields. For example, in some embodiments, divisional granularity input fields 510 can include selection fields (e.g., 511-512) for selecting various divisions and/or subdivisions of a company and/or enterprise, such as a division, a super department, a department, a category, etc., or to select all divisions. For example, as shown in FIG. 5, a user (e.g., 350 (FIG. 3)) can use divisional granularity input fields 510 to specify the division granularity to apply when inputting and/or displaying information in user interface display 500. For example, as shown in FIG. 5, a user (e.g., 350 (FIG. 3)) can specify, using division selection field 511, that the inputs and displays in user interface display 500, and/or the bidding specified using user interface display 500, will apply to the Fashion division, and can specify, using super department selection field 512, that all super departments within the Fashion division apply. In many embodiments, the options available to select within super department selection field can be based on the division selected using division selection field 511.

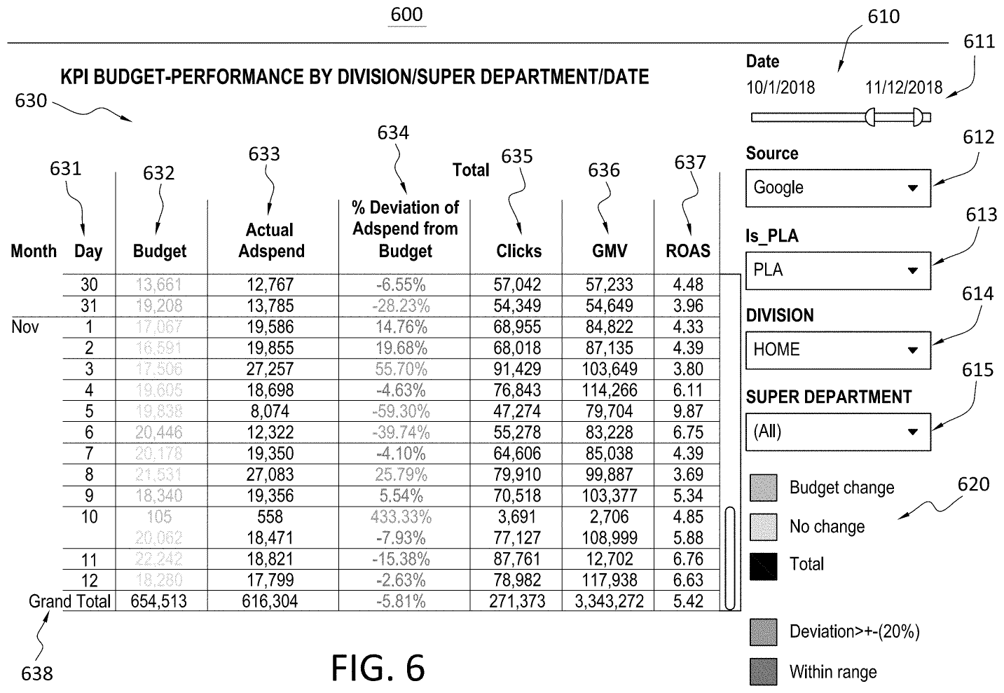

In some embodiments, when the divisions and/or subdivisions selected have historical budget information, such as based on previous budget allocations, previous allocation information field 520 can display a notification that previous budgets have been set for the division and/or super department selected. In some embodiments, a user (e.g., 350 (FIG. 3)) can click on previous allocation information field 520 to display information about the previous budget allocations, and/or performance results, such as shown in user interface display 600, as shown in FIG. 6 and described below.

In several embodiments, search engine selection fields 530 can include search engine selection options, such as an all selection 531, a Google selection 532, a Bing selection 533, a Yahoo selection 534, and/or other suitable search engine selection options. In a number of embodiments, a user (e.g., 350 (FIG. 3)) can select one of the search engine selection options (e.g., 531-534) to specify the search engine to apply when inputting and/or displaying information in user interface display 500. For example, as shown in FIG. 5, a user (e.g., 350 (FIG. 3)) can select all selection 531 to specify that the inputs and displays in user interface display 500, and/or the bidding specified using user interface display 500, will apply to, and/or be based on, all of the search engine options available.

In many embodiments, ad type selection fields 540 can include ad type selection options, such as an all selection 541, a PLA (product listing advertisement) selection 542, a textual (keyword) selection 543, and/or other suitable ad type selection options. In a number of embodiments, a user (e.g., 350 (FIG. 3)) can select one of the ad type selection options (e.g., 541-543) to specify the advertisement type to apply when inputting and/or displaying information in user interface display 500. For example, as shown in FIG. 5, a user (e.g., 350 (FIG. 3)) can select all selection 531 to specify that the inputs and displays in user interface display 500, and/or the bidding specified using user interface display 500, will apply to, and/or be based on, all of the ad type options available, such as both PLA advertisements and textual (keyword) advertisements.

In some embodiments, previous week information display fields 550 can display information about, and/or performance results for, the previous week for the combination of division (if applicable), super department (if applicable), search engine option, and ad type option, based on the selections in division granularity input fields 510, search engine selection fields 530, and ad type selection fields 540. In a number of embodiments, previous week information display fields 550 can include a GMV (gross merchandise volume) field 551, an ad spend field 552, a performance result field 553, and/or other suitable fields. For example, ad spend field 552 can display that $183,572.52 was spent on SEM bidding during the previous week for the Fashion division (and all super departments therein), for all search engines, and for all ad types; GMV field 551 can display that $698,527.92 was the gross merchandise volume for the previous week for the Fashion division (and all super departments therein), for all search engines, and for all ad types; and performance result field 553 can display that the ROAS is 3.81 based on these numbers over the previous week for the Fashion division (and all super departments therein), for all search engines, and for all ad types. This data and other data shown in FIGS. 5-6 can be exemplary data for illustrative purposes only. In the same or other embodiments, other or additional performance results can be displayed in performance result field 553. For example, contribution profit on ad spend (CPOAS), cost per acquired customer (CAC), and/or other suitable performance metric can be used to display performance results in performance result field 553.

In many embodiments, next week input fields 560 can allow a user (e.g., 350 (FIG. 3)) to input objectives for the following week and display constraints on one or more inputs. In several embodiments, next week input fields 560 can include an ad spend selection button 561, an ad spend constraint display field 562, performance objective selection fields 565, an estimate button 569, and/or other suitable fields or elements. In a number of embodiments, ad spend selection button 561 can be used to enter an amount to spend for SEM advertisements in the next week, based on the combination of division (if applicable), super department (if applicable), search engine option, and ad type option, based on the selections in division granularity input fields 510, search engine selection fields 530, and ad type selection fields 540. For example, as shown in FIG. 5, a user (e.g., 350 (FIG. 3)) can use ad spend selection button 561 to select to spend $200,000.00 during the next week for the Fashion division (and all super departments therein), for all search engines, and for all ad types. In many embodiments, the ad spend amount that can be entered using ad spend selection button 561 can be constrained by lower and/or upper bounds, which can be displayed in ad spend constraint display field 562. As described below in further detail, the constraints can prevent a user (e.g., 350 (FIG. 3)) from entering an ad spend amount that is far less or far exceeds the ad spend for the previous week and/or the historical ad spend.

In a number of embodiments, performance objective selection fields 565 can include performance objective selection options, such as a ROAS performance objective selection 566, a CPOAS performance objective selection 567, a CAC performance objective selection 568, and/or other suitable performance objective selections. In several embodiments, a user (e.g., 350 (FIG. 3)) can select one of the performance objective selection options (e.g., 566-568) to specify the performance objective to apply when allocating budgets and/or generating forecasts. For example, as shown in FIG. 5, a user (e.g., 350 (FIG. 3)) can select ROAS performance objective selection 566 to specify that the performance objective used for allocation and/or forecasting will be ROAS.

In several embodiments, once the ad spend has been entered in ad spend selection button 561 and the performance objective has been selected in performance objective selection fields 565, a user (e.g., 350 (FIG. 3)) can select estimate button 569 to generate an allocation and/or forecast, which are displayed in daily allocation forecast display 570 and/or performance forecast display fields 580, described below.

In several embodiments, daily allocation forecast display 570 can display a forecast of ad spending for each day of the upcoming week, as shown as a bar graph in daily allocation forecast display 570 in FIG. 5, and/or a forecast of a cumulative amount spent after each day of the upcoming week, as shown as a line graph in daily allocation forecast display 570 in FIG. 5.

In many embodiments, performance forecast display fields 580 can display information about budgets and/or forecasted results for the upcoming week for the combination of division (if applicable), super department (if applicable), search engine option, and ad type option, based on the selections in division granularity input fields 510, search engine selection fields 530, and ad type selection fields 540, and/or based on the ad spend selected in ad spend selection button 561 and/or the performance objective selected in performance objective selection fields 565. In a number of embodiments, performance forecast display fields 580 can include a forecasted GMV field 581, a budgeted ad spend field 582, a performance forecast field 583, and/or other suitable fields. For example, budgeted ad spend field 582 can display that $200,000.00 is budgeted to be spent on SEM bidding during the upcoming week for the Fashion division (and all super departments therein), for all search engines, and for all ad types; forecasted GMV field 581 can display that the gross merchandise volume for the upcoming week for the Fashion division (and all super departments therein), for all search engines, and for all ad types is forecasted to be in the range of $612,369.20 to $827,696.26; and performance forecast field 583 can display that the ROAS is forecasted to be in the range of 3.06 to 4.14 for the upcoming week for the Fashion division (and all super departments therein), for all search engines, and for all ad types. In the same or other embodiments, other or additional forecasted performance results can be displayed in performance forecast field 583. For example, CPOAS, CAC, and/or other suitable performance metric can be used to display forecasted performance results in performance forecast field 583. In many embodiments, performance forecast field 583 can include performance forecasts for at least the performance objective selected in performance objective selection fields 565.

In several embodiments, after a user (e.g., 350 (FIG. 3)) has reviewed the estimate provided in daily allocation forecast display 570 and/or performance forecast display fields 580, and made any further adjustments desired by the user, the user can select apply button 590 to apply the selections made in user interface display 500 for the SEM bidding in the upcoming week.

Returning to FIG. 4, in several embodiments, method 400 also can include a block 410 of receiving a total allocation amount for a predetermined time period in an allocation amount input field of the input fields of the graphical user interface. The allocation amount input field can be similar or identical to ad spend selection button 561 (FIG. 5). In some embodiments, the predetermined time period can be a week, such as the upcoming seven days. In other embodiments, the predetermined time period can be another suitable time period, such as a day, two days, three days, four days, five days, six days, two weeks, three weeks, four weeks, or a month, for example. For example, the total allocation amount can be the amount entered in ad spend selection button 561 (FIG. 5), which can be the amount budgeted for ad spend over the upcoming seven days. In some embodiments, the total allocation amount can be set for the total enterprise, per division, or per subdivision (e.g., super department).

In several embodiments, the allocation amount input field can constrain the total allocation amount between a lower bound and an upper bound based on a previous allocation amount. For example, the lower bound and/or upper bound can be displayed in ad spend constraint display field 562 (FIG. 5). In some embodiments, the previous allocation amount can be the total allocation amount budgeted for ad spend during the previous seven days, such as displayed in ad spend field 552. In other embodiments, the previous allocation amount can be the total allocation amount budgeted historically in any previous predetermined time period (e.g., seven-day time period) for the past month, the past year, or since budgets have been set for the applicable division and/or super department selected, if any. In some embodiments, the lower bound can be approximately 20% of the previous allocation amount and/or the upper bound can be approximately 200% of the previous allocation amount. In other embodiments, the lower bound and/or upper bound can be another percentage of the previous allocation amount and/or historical allocation amounts. In some embodiments, the total allocation amount can be constrained to a range that will allow a forecast prediction to be made for the performance objective. For example, a sudden increase of budget by 500% can be rejected, as the performance objective can be difficult to forecast without historical performance information being within a range of or the total allocation amount in which forecasts can be extrapolated to provide performance guidance.

In a number of embodiments, method 400 additionally can include a block 415 of receiving a performance objective in a performance objective input field of the input fields of the graphical user interface. The performance objective input field can be similar or identical to performance objective selection fields 565 (FIG. 5). In several embodiments, the performance objective input field can provide a set of options for selection of the performance objective. For example, the set of options can be similar or identical to ROAS performance objective selection 566 (FIG. 5), CPOAS performance objective selection 567 (FIG. 5), and/or CAC performance objective selection 568 (FIG. 5). In many embodiments, the performance objective can be a KPI, such as ROAS, CPOAS, CAC, or another suitable KPI.

In some embodiments, method 400 optionally can include a block 420 of receiving a division granularity selection in one or more division granularity fields of the input fields of the graphical user interface. The division granularity input fields can be similar or identical to division granularity input fields 510 (FIG. 5). For example, the division granularity selection can be a division selected in division selection field 511 (FIG. 5) and/or a subdivision (e.g., super department) selected in super department selection field 512 (FIG. 5). In some cases, the division and/or super department selected can be similar or identical “all” divisions and/or super departments or a specific division or super department. For example, the Fashion division and all super departments thereunder can be selected, as shown in FIG. 5.

In several embodiments, method 400 further can include a block 425 of automatically generating an allocation of the total allocation amount among combinations selected from multiple advertisement types and multiple search engines based at least in part on the total allocation amount and the performance objective according to allocation balancing rules. For example, the total allocation amount can be allocated to different search engine and ad type combinations. For example, a first amount of the total allocation amount can be allocated to product listing ads on the Google search engine, a second amount of the total allocation amount can be allocated to textual ads on the Google search engine, a third amount of the total allocation amount can be allocated to product listing ads on the Bing search engine, a fourth amount of the total allocation amount can be allocated to textual ads on the Bing search engine, a fifth amount of the total allocation amount can be allocated to product listing ads on the Yahoo search engine, a sixth amount of the total allocation amount can be allocated to textual ads on the Yahoo search engine. In some embodiments, the allocation balancing rules can include allocating amounts to equalize predicted performance under the performance objective in each of the combinations selected from multiple advertisement types and multiple search engines. For examples, if ROAS is selected as the performance objective, the amount allocated to each of the combinations of search engines and ad types can be set to achieve the desired ROAS in each of these combinations, which can involve allocating more of the budget to certain combinations and less to others.

In several embodiments, such as when a division granularity selection is provided in block 420, block 425 can include automatically allocating between subdivisions of the division granularity selection based at least in part on the total allocation amount and the performance objective according to the allocation balancing rules. In some embodiments, the allocation balancing rules can include allocating amounts that equalize predicted performance under the performance objective in each of the combinations selected from multiple advertisement types and multiple search engines in each of the subdivisions. For example, if the division is set to Fashion and the super department to all, as shown in FIG. 5, the total allocation amount can be allocated among each of the super departments under the Fashion division within each of the combinations of search engines and ad types in a way that is set to achieve the desired ROAS in each of these combinations of super departments, search engines, and ad types. For example, if spending $1,000 in super department B yields revenue of $10,000, and spending $1,000 in super department A yields $5,000 of revenue, then more of the budget can be allocated to super department B in order to equalize performance, as estimated based on past empirical data.

In many embodiments, the total allocation amount can be allocated to each super department, search engine, and ads type combination according to historical revenue performance to equalize predicted performance under the performance objective (e.g., ROAS) across the different super departments of the division. In other words, for super departments A and B, it can be desired that ROAS_{A}=ROAS_{B}, such that:

$${ROAS}_{A} = \frac{{revenue}_{A}}{ad {spend}_{A}} = {ROAS}_{B} = \frac{{revenue}_{B}}{ad {spend}_{B}} ⇒ \frac{ad {spend}_{A}}{ad {spend}_{B}} = \frac{{revenue}_{A}}{{revenue}_{B}} .$$

In many embodiments, different budget allocations in each super department, search engine, and/or ad type combination can be used to achieve different bidding efficiency. Different weighted linear models can be generated for each super department, search engine, and ad type combination. For example, a model can be built to a seven-day ad spend (spd) and seven-day revenue (r), based on elasticity principles, in the form of:

r=β₀spd^{β}^{₁},

which can be linearized using log linearization as follows:

log(r)=β₁ log(spd)+log(β₀),

where β₀ and β₁ are coefficients for each model that are derived based on the historical performance to fit the curve in the model to the actual historical performance.

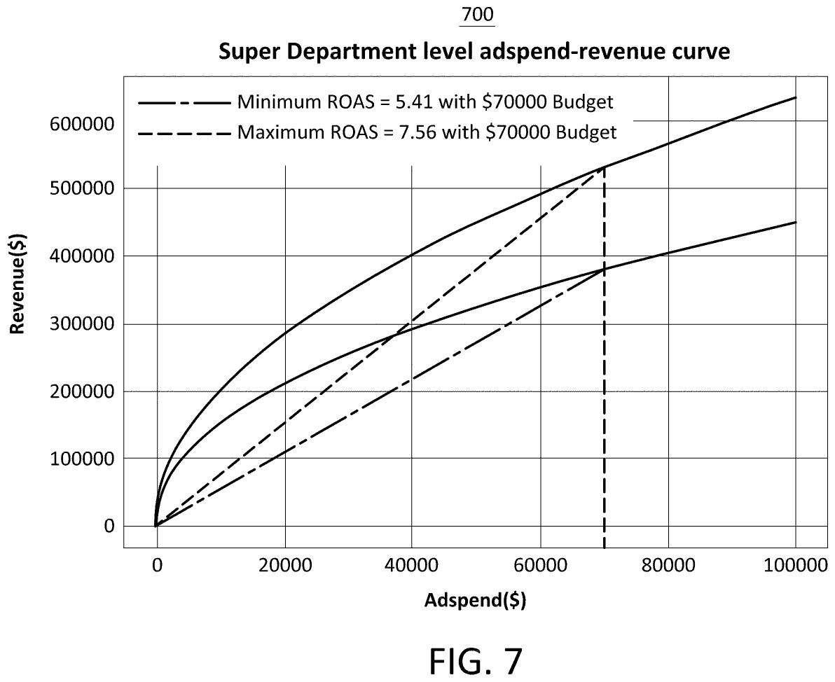

Jumping ahead in the drawings, FIG. 7 shows a graph 700 of an ad spend versus revenue curve at a super department level. As shown in FIG. 7, when allocating a budget of $70,000 to a super department, historical performance indicates that ROAS would be between 5.41 and 7.56. Generally, revenue would be within the range of the upper and lower curves, based on different ad spend values. Based on elasticity principles, including diminishing returns, the ROAS will decrease as ad spending increases.

In many embodiments, the data for used for developing each model can be based on data that is aggregated by week to exclude effects for different days of the week. In several embodiments, for each model, the most recent two-month data and the same three-month period from the previous year can be used and aggregated by week. For example, to predict the revenue in the week of Sep. 3, 2018 to Sep. 9, 2018, aggregated features can be used from July 2018 to August 2018, and from August 2017 to October 2017. Different weights (wᵢ) can be assigned to the data for this year and last year to build the models. For example, the data for this year can be weighted at 0.3, and the data for last year can be weighted at 0.2 for typical (non-holiday) seasons, while the data for this year can be weighted at 0.3 and the data for last year can be weighted at 0.7 for last year for holiday seasons, as the performance during the holiday season last year can be more relevant to predicted performance during this holiday season than the sales from the past months this year, but during non-holiday seasons, the last two months can be more predicted than the performance last year. In other embodiments, other weights can be used. The solution can be determined by minimizing the weighted sum of squares:

$${arg min}_{w , β} {\sum }_{i = 1}^{n} {w}_{i} {\vert log ( {r}_{i} ) - {β}_{1} log ( spd ) - log ( {β}_{0} ) \vert}^{2} ,$$

where wᵢ>0 is the weight of i^{th} observation. In many embodiments, with a specified seven-day budget, the model can predict a range of seven-day revenue within a 90% confidence interval.

Returning to FIG. 4, in a number of embodiments, method 400 additionally can include a block 430 of automatically generating one or more performance forecasts based on the allocation. In many embodiments, the one or more performance forecasts can include predicted ranges based at least in part on historical performance data. For example, the performance forecasts can include GMV, ROAS, CPOAS, CAC, and/or other suitable performance forecasts, which can be forecasted using the revenue predicted in the allocation generated in block 425. In several embodiments, each of these forecasts can include a range predicted by historical performance.

In several embodiments, method 400 further can include a block 435 of automatically generating a daily allocation forecast across the predetermined time period based on the allocation. In some embodiments, the allocation generated in block 425 can be allocated to each day of the upcoming week based on day-of-week effect, such that certain days of the week receive more of the budget than other days of the week. For example, certain days of the week can generally have higher performance than other days of the week, and the amount allocated to each day can be adjusted to equalize the performance objective (e.g., ROAS), or based on user input.

In a number of embodiments, method 400 additionally can include a block 440 of displaying the daily allocation forecast and the one or more performance forecasts in the output fields of the graphical user interface. For example, the daily allocation forecast can be displayed in daily allocation forecast display 570 (FIG. 5), and the performance forecasts can be displayed in performance forecast display fields 580 (FIG. 5). In several embodiments, the daily allocation forecast displayed in at least one of the output fields of the graphical user interface can include a daily allocation amount for each day of the predetermined time period a cumulative allocated amount for each day of the predetermined time period. For example, as shown in daily allocation forecast display 570 (FIG. 5), a spending distribution graph can be displayed to depict how the ad spend will be distributed in the next 7 days, and a cumulative ad spend can be shown starting from 0 to the forecasted target ad spend by day 7.

In several embodiments, method 400 further can include, after receiving an approval, a block 445 of automatically bidding for each of the multiple advertisement types at each of the multiple search engines based at least in part on the daily allocation forecast. For example, after the daily allocation forecast and the one or more performance forecasts are displayed to the user (e.g., 350 (FIG. 3)), the user can approve the allocation and forecasts, such as by clicking the apply button 590 (FIG. 5). In several embodiments, bids can be generated using conventional approaches, but based on the allocation generated and approved. For example, bids for each product listing advertisement and textual advertisement can be generated based on SEM predicted signals and the forecast performance objective. The SEM predicted signals can be information such as revenue per click, which can be received by performance bidding system 300 (FIG. 3) and/or generated in a conventional manner by performance bidding system 300 (FIG. 3) from another system. In many embodiments, the bid generation can be done conventionally based on the SEM predicted signals, but can based on the budget allocated among the different combinations, as described above.

For example, in many embodiments, different models for the specified performance objective can be built, such as random forest models, XGBoost models, or other suitable models, to predict signals to generate bids in order to achieve the desired performance objective. Using a performance objective of ROAS, for example, with the forecasted ROAS, each bid can be set based on its predicted revenue per click (rpc), as follows:

$${bid}_{i} ∝ \frac{{rpc}_{i}}{{ROAS}_{i}}$$

In several embodiments, once the bids are set, they can be sent to the search engines for the bid amounts determined.

In a number of embodiments, block 445 can include a block 450 of estimating a predicted total amount consumed for a day based on actual amounts consumed during a first portion of the day and historical amounts consumed. In several embodiments, the estimate of the predicted total amount consumer can be used for ad spend pacing control, as provided in blocks 450 and 455 (described below). Often times, the traffic demand pattern can be similar between today and yesterday and last week on the same day of the week. For each super department, the ad spend for the first four hours (or another suitable number of hours) of today can be compared with the ad spend data from yesterday and last week on the same day of the week. With total ad spend for those two days, the projected ad spend can be predicted today.

In some embodiments, the predicted total amount consumed for the day (e.g., today) can be estimated using the following formula:

$${S}_{T} = \frac{{\sum }_{i = 1}^{H} {S}_{iT}}{{\sum }_{i = 1}^{H} {S}_{iY}} * {S}_{Y} ,$$

where S_{T} is the ad spend for today, S_{Y} is the ad spend for yesterday, H is the available hourly ad spend at the time of the pacing control job, and sᵢ is the hourly ad spend at i^{th} hour.

In several embodiments, block 445 also can include a block 455 of adjusting bidding for a remainder of the day based on the predicted total amount consumed for the day and an allotment for the day in the daily allocation forecast. For example, if the predicted total amount consumed for the day exceeds the allotment for the day in the daily allocation forecast, adjustments can be made to bids. In some embodiments, pacing control jobs can be run throughout the day at specified times to make adjustments through the day, such as at 6 am on a daily basis, and a second round of pacing adjustment jobs will be submitted if necessary with similar process at 11 am, for example. Blocks 445, 450, and/or 455 can be performed not only automatically, but also in real-time throughout the day so that performance bidding system 300 (FIG. 3) stays within the allotment for that same day.

Jumping ahead in the drawings, FIG. 6 illustrates an exemplary user interface display 600 to allow a user (e.g., 350 (FIG. 3)) to view performance results using performance bidding system 300 (FIG. 3). User interface display 600 is merely exemplary, and embodiments of the user interface display are not limited to the embodiments presented herein. The user interface display can be employed in many different embodiments or examples not specifically depicted or described herein, and can include other suitable elements. In many embodiments, the interface provided by performance bidding system 300 (FIG. 3) on user computer 340 (FIG. 3) can display user interface display 600.

In a number of embodiments, user interface display 600 can include selector fields 610, key 620, and output area 630. In several embodiments, input fields 610 can include date range selector 611, search engine selector 612, ad type selector 613, division selector 614, subdivision selector 615, and/or other suitable selectors. In several embodiments, a user (e.g., 350 (FIG. 3)) can select a date range using date range selector 611, one or more search engines using search engine selector 612, one or more ad types using ad type selector 613, one or more divisions using division selector 614, and one or more subdivisions (e.g., super departments) using subdivision selector 615, in order to set the parameters for the data displayed in output area 630.

In some embodiments, output area 630 can display data that shows the details about the amounts allocated and the performance. For example, output area 630 can include a day column 631, to display information on a daily basis, a budget column 632 to display the amount budgeted for each day, an actual ad spend column 633 to display the actual amount spend for each day, a percentage deviation column 634 to display the percentage in which the actual ad spend in actual ad spend column 633 deviated from the budgeted ad spend in budget column 632, a clicks column 635 to display the number of clicks for each day, a GMV column 636 to display the GMV for each day, a performance objective column 637, to display the results for the performance objective (e.g., ROAS) for each day. In several embodiments, output area 630 can include a grand total row 638, which can display the totals in each column for the date range selected in date range selector 611.

In a number of embodiments, the data in output area 630 can be color-coded, shaded, or otherwise coded to provide additional information, as described by key 620. For example, whether the budget was changed or not can be indicated using the coding in budget column 632, and whether the deviation was within a predetermined range (e.g., 20%, or another suitable range) can be indicated using the coding in percentage deviation column 634.

Returning to FIG. 3, in several embodiments, user interface system 301 can at least partially perform block 405 (FIG. 4) of providing a graphical user interface comprising input fields and output fields, block 410 (FIG. 4) of receiving a total allocation amount for a predetermined time period in an allocation amount input field of the input fields of the graphical user interface, block 415 (FIG. 4) of receiving a performance objective in a performance objective input field of the input fields of the graphical user interface, block 420 (FIG. 4) of receiving a division granularity selection in one or more division granularity fields of the input fields of the graphical user interface, and/or block 440 (FIG. 4) of displaying the daily allocation forecast and the one or more performance forecasts in the output fields of the graphical user interface.

In several embodiments, allocation system 302 can at least partially perform block 425 (FIG. 4) of automatically generating an allocation of the total allocation amount among combinations selected from multiple advertisement types and multiple search engines based at least in part on the total allocation amount and the performance objective according to allocation balancing rules, block 430 (FIG. 4) of automatically generating one or more performance forecasts based on the allocation, and/or block 435 (FIG. 4) of automatically generating a daily allocation forecast across the predetermined time period based on the allocation.

In a number of embodiments, bid system 303 can at least partially perform block 445 (FIG. 4) of automatically bidding for each of the multiple advertisement types at each of the multiple search engines based at least in part on the daily allocation forecast.

In several embodiments, pacing system 304 can at least partially perform block 450 (FIG. 4) of estimating a predicted total amount consumed for a day based on actual amounts consumed during a first portion of the day and historical amounts consumed, and/or block 455 (FIG. 4) of adjusting bidding for a remainder of the day based on the predicted total amount consumed for the day and an allotment for the day in the daily allocation forecast.

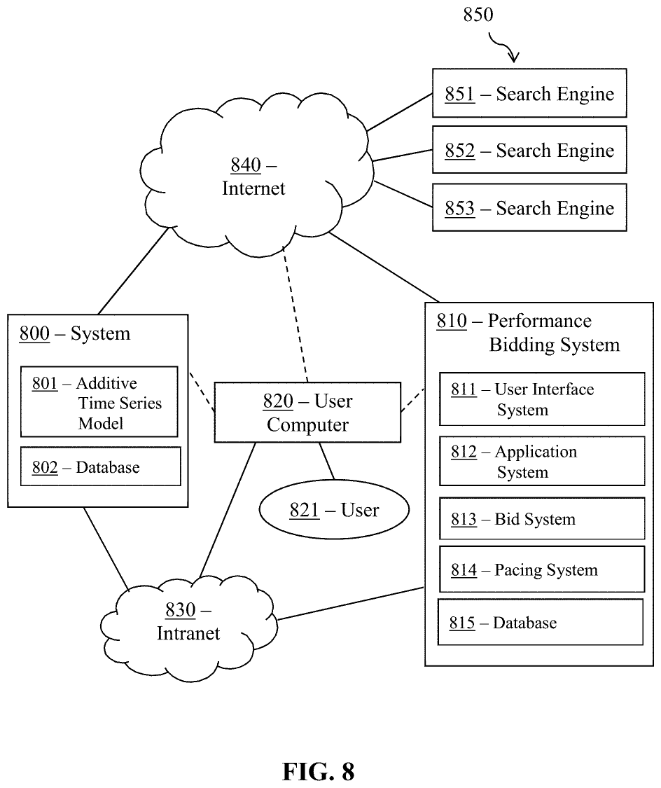

Turning ahead in the drawings, FIG. 8 illustrates a block diagram of a system 800 that can be employed for detecting and rectifying abnormal ad spends, according to an embodiment. System 800 is merely exemplary and embodiments of the system are not limited to the embodiments presented herein. The system can be employed in many different embodiments or examples not specifically depicted or described herein. In some embodiments, certain elements, modules, or systems of system 800 can perform various procedures, processes, and/or activities. In other embodiments, the procedures, processes, and/or activities can be performed by other suitable elements, modules, or systems of system 800. System 800 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 800 described herein.

In many embodiments, system 800 can include an additive time series model 801 and/or a database 802. In many embodiments, the elements, modules, or systems of system 800 and/or additive time series model 801 can include modules of computing instructions (e.g., software modules) stored at non-transitory computer readable media that operate on one or more processors. In other embodiments, the elements, modules, or systems of system 800 and/or additive time series model 801 can be implemented in hardware. System 800 can be a computer system, such as computer system 100 (FIG. 1), as described above, and can be a single computer, a single server, or a cluster or collection of computers or servers, or a cloud of computers or servers. In another embodiment, a single computer system can host system 800. Additional details regarding system 800 and the components thereof are described herein.

In a number of embodiments, system 800 can be in data communication via a computer network, such as Intranet 830 or Internet 840, with one or more other systems, such as a performance bidding system 810. In some embodiments, system 800 can include performance bidding system 810. In many embodiments, performance bidding system 810 can be similar or identical to performance bidding system 300 (FIG. 3). In several embodiments, performance bidding system 810 can comprise a user interface system 811, an application system 812, a bid system 813, a pacing system 814, and/or a database 815, that are respectively similar or identical to user interface system 301 (FIG. 3), allocation system 302 (FIG. 3), bid system 303 (FIG. 3), pacing system 304 (FIG. 3), and/or database 305 (FIG. 3).

In some embodiments, system 800 and/or performance bidding system 810 each can be in data communication directly or through the computer network, such as Intranet 830 or Internet 840, with one or more user computers, such as user computer 820. In many embodiments, user computer 820 can be similar or identical to user computer 340 (FIG. 3). In a few embodiments, user computer 820 can be used by users, such as user 350 (FIG. 3) or a user 821. In a number of embodiments, system 800 can allow user 821 to provide commands, user configurations, or receive messages, such as alerts, via a user interface executed on user computer 820. In many embodiments, performance bidding system 810 can host a website that allows users, such as business managers or marketing managers, to manage bidding for SEM.

In several embodiments, system 800 and/or performance bidding system 810 each can be in data communication through Internet 840 with one or more search engines, such as search engines 850, which can include search engine 851, 852, and/or 853, for example. In many embodiments, search engines 850 can be similar or identical to search engines 360 (FIG. 3).

Meanwhile, in many embodiments, system 800 and/or performance bidding system 810 also can be configured to communicate with and/or include one or more databases, such as database 305 (FIG. 3), database 802, or database 815, and/or other suitable databases. The one or more databases can include user configurations and historical data for bidding, web traffic, ad spends, and/or performance, for example, among other data as described herein.

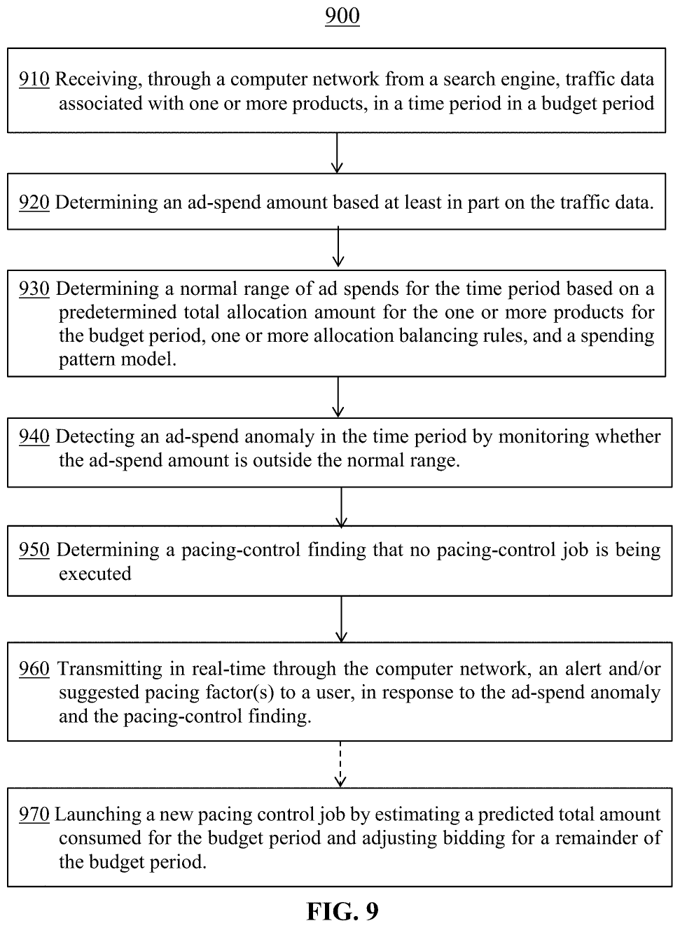

Turning ahead in the drawings, FIG. 9 illustrates a flow chart for a method 900. In some embodiments, method 900 can be a method of detecting and rectifying abnormal ad spends. Method 900 is merely exemplary and is not limited to the embodiments presented herein. Method 900 can be employed in many different embodiments or examples not specifically depicted or described herein. In some embodiments, the procedures, the processes, and/or the activities of method 900 can be performed in the order presented. In other embodiments, the procedures, the processes, and/or the activities of method 900 can be performed in any suitable order. In still other embodiments, one or more of the procedures, the processes, and/or the activities of method 900 can be combined or skipped.

In many embodiments, system 800 (FIG. 8) can be suitable to perform method 900 and/or one or more of the activities of method 900. In these or other embodiments, one or more of the activities of method 900 can be implemented as one or more computing instructions configured to run at one or more processors and configured to be stored at one or more non-transitory computer readable media. Such non-transitory computer readable media can be part of a computer system such as system 800 (FIG. 8). The processor(s) can be similar or identical to the processor(s) described above with respect to computer system 100 (FIG. 1).

In some embodiments, method 900 and other blocks in method 900 can include using a distributed network including distributed memory architecture to perform the associated activity. This distributed architecture can reduce the impact on the network and system resources to reduce congestion in bottlenecks while still allowing data to be accessible from a central location.

Referring to FIG. 9, method 900 can include a block 910 of receiving, through a computer network from a search engine, traffic data associated with one or more products, in a time period of a budget period. In many embodiments, the computer network can be similar or identical to Internet 330 (FIG. 3), Intranet 830 (FIG. 8), or Internet 840 (FIG. 8). The search engine can be similar or identical to search engines 360 (FIG. 3), 850 (FIG. 8), and/or Google, Bing, or Yahoo search engines, or other suitable search engines. In some embodiments, the traffic data can include data associated with web traffic to a website, such as an e-commerce website, driven by advertisements for the one or more products on the search engine. In a few embodiments, the one or more products can belong to the same division, department, super department, or category (such as the Fashion division) and share the same budget for SEM advertisements. The traffic data can be transmitted from the search engine in real-time by streaming or near-real-time (NRT) in a batch with a brief delay, such as an hour, 2 hours, 3 hours, or 5 hours, etc. In some embodiments, the time period can be an hour, 2 hours, or 3 hours, etc., and the budget period can be a day, a week, 10 days, etc.

In some embodiments, method 900 further can include a block 920 of determining an ad-spend amount based at least in part on the traffic data. In many embodiments, the ad-spend amount can be determined based on a formula associated with the search engine based at least in part on the traffic data. For example, the formula for a specific search engine can be (a+b*N), where a and b are constants and N is the number of clicks in the time period.

In a number of embodiments, method 900 further can include a block 930 of determining a normal range of ad spends for the time period based on: (a) a predetermined total allocation amount for the one or more products for the budget period, (b) one or more allocation balancing rules, and/or (c) a spending pattern model. In some embodiments, the predetermined total allocation amount can be provided by a user (e.g., user 350 (FIG. 3) or user 821 (FIG. 8)) via an input element (e.g., ad spend selection button 561 (FIG. 5)) of a user interface (e.g., user interface 500 (FIG. 5)).

In many embodiments, the one or more allocation balancing rules used in block 930 can be associated with at least one or more of: (a) one or more search engines comprising the search engine; (b) one or more respective advertisement types for each of the one or more search engines; (c) respective historical performance for each of the one or more respective advertisement types for each of the one or more search engines; and/or (d) respective predicted performance for each of the one or more respective advertisement types for each of the one or more search engines. In some embodiments, the one or more allocation balancing rules can comprise allocating the predetermined total allocation amount based on each of the one or more respective advertisement types for each of the one or more search engines to equalize the respective predicted performance for the each of the one or more respective advertisement types for the each of the one or more search engines under a predetermined performance objective. In several embodiments, the allocation balancing rules can be similar or identical to those rules used in block 425 (FIG. 4), as described above.

Still referring to FIG. 9, in a number of embodiments, the spending pattern model for block 930 can comprise an additive time series model trained based at least in part on the traffic data. In some embodiments, the additive time series model can be similar or identical to additive time series model 801 (FIG. 8). In many embodiments, the additive time series model can comprise a function of one or more of: (a) an ad-spend trend for the one or more products; (b) a periodic ad-spend pattern for the one or more products; and/or (c) a holiday effect on ad spends for the one or more products.

In a number of embodiments, the spending pattern model in block 930 can comprise one or more suitable statistical models, such as Holt-Winters additive method or ARIMA models, to derive the ad-spend trend, the periodic pattern, and/or the holiday effects and/or to generate the function for predicting future ad-spend ranges based at least in part on historical web traffic data and/or historical ad spends during any suitable periods of time (e.g., 2 years, 3 years, 5 years, etc.). In similar or different embodiments, the spending pattern model can comprise one or more machine learning models trained periodically (e.g., daily, weekly, bi-weekly, etc.) to predict future ad-spend ranges based at least in part on historical real-time or near-real-time web traffic data from the search engine and/or historical ad spends. In some embodiments, the spending pattern model can be in data communication via a computer network, such as Internet 330 (FIG. 3), Intranet 830 (FIG. 8), or Internet 840 (FIG. 8), with one or more machine learning models or systems. In many embodiments, the function for the additive time series model can be generated by any suitable machine learning models, such as a linear regression model or logistic growth model, of the spending pattern model.

In some embodiments, block 930 further can determine the normal range of ad spends for the one or more products for the time period based at least in part on user configurations. In a few embodiments, the user configurations can be received, from a user computer (e.g., user computer 340 (FIG. 3) or user computer 820 (FIG. 8)) through the computer network (e.g., Internet 330 (FIG. 3), Intranet 830 (FIG. 8), or Internet 840 (FIG. 8)), the user configurations associated with an upper boundary and a lower boundary for an acceptable range of ad spends, such as ±10% or +5%˜−10% based on a predicted ad-spend amount or adjustments of a predicted ad-spend range, for example. In several embodiments, the user further can provide a tolerance range (e.g., ±1% or a difference from the boundaries of less than $100) so that insignificant anomalies can be ignored.

Still referring to block 930 in FIG. 9, in some embodiments, the function adopted by the additive time series model for estimating the seasonality and trend of ad spends for each division (or department, super department, category, etc.), each search engine, and each ad type combination, can be represented as:

y(t)=g(t)+s(t)+h(t)+∈ₜ, wherein:
t—a certain time;
g(t)—a trend function for ad spends;
s(t)—a function of periodic changes in ad spends (e.g., hourly, weekly, annually, and/or seasonally);
h(t)—a function of holiday effects on ad spends; and
∈ₜ—normally distributed error terms.

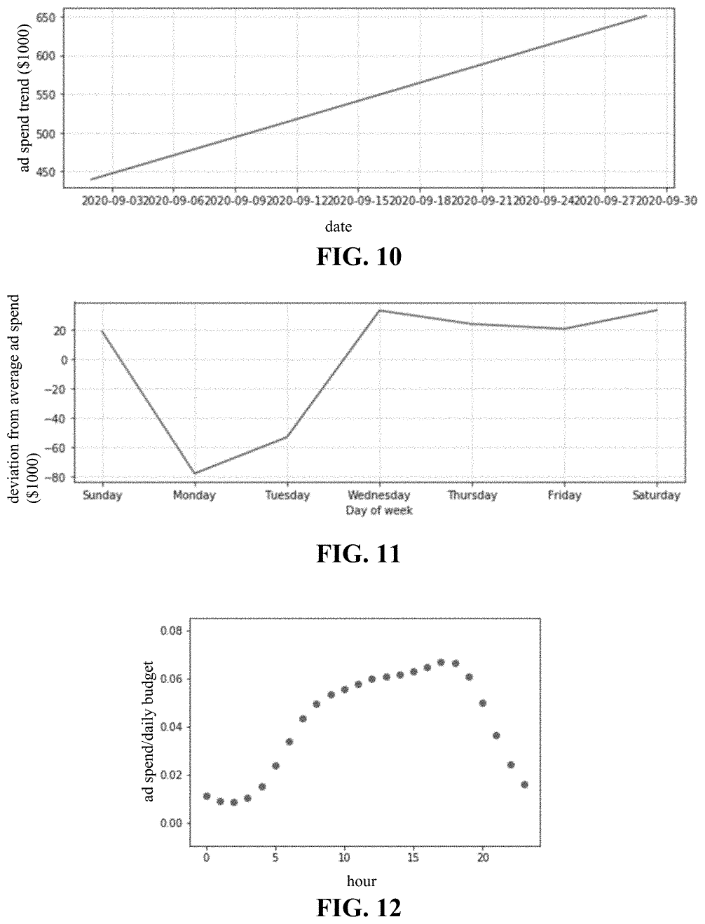

In some embodiments, the trend function (e.g., g(t)), the function of periodic changes (e.g., s(t)), and/or the function (e.g., y(t)) can be generated based on one or more exemplary ad spend patterns as shown in FIGS. 10-13 and described below.

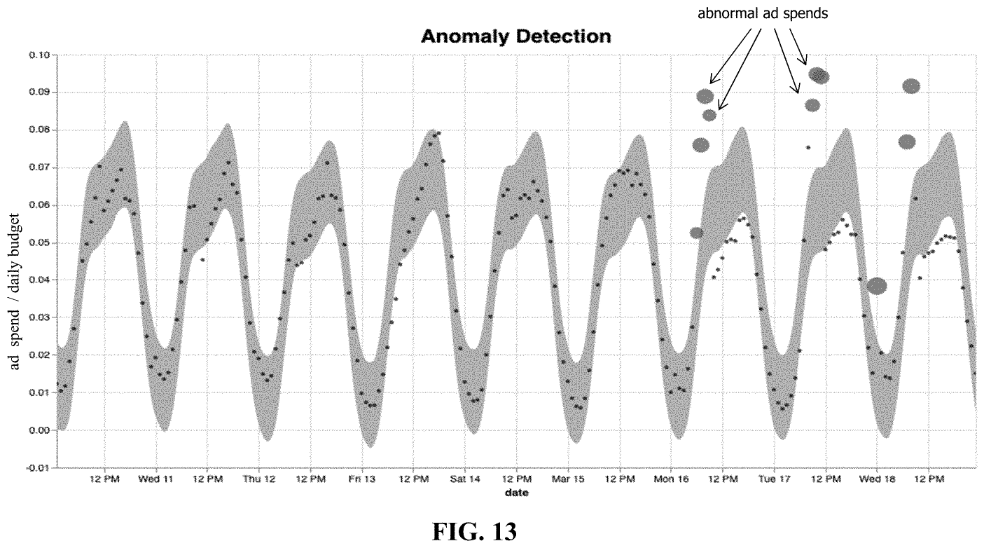

Turning ahead in the drawings, FIGS. 10-13 illustrate various exemplary ad spend patterns over a period of time. In an embodiment, the trend function for accumulated ad spends for a division (e.g., g(t)) can be a straight line as shown in FIG. 10. In another embodiment, the function of periodic changes in ad spends (e.g., s(t)) can comprise a weekly change pattern as shown in FIG. 11 and/or a daily change pattern as shown in FIG. 12. In yet another embodiment, the function for estimating normal ranges of ad spends on a search engine for a division (e.g., y(t)) can be illustrated in FIG. 13 with the shaded area showing the predicted normal ranges in the 9-day period. In the exemplary embodiment, the dots can represent ad-spend records calculated based on the web traffic data in block 920 (FIG. 9). In some embodiments, various tolerances further can be adopted when an ad spend record is outside the respective normal range. The tolerances can be a fixed percentage, a constant, or vary in the predicted period of time. For example, in an embodiment shown in FIG. 13, all dots (i.e., the ad-spend records) fallen below the shaded area (i.e., the normal range) can be acceptable, while some of the dots above the shaded area are considered abnormal. Further, in this embodiment in FIG. 13, the tolerance for ad-spend records above the shaded area at about the same period of time on Tuesday (e.g., during 6-12 am on the 17^{th}) can be higher than that on the other days of week, such as Monday (e.g., the 16^{th}) and/or Wednesday (e.g., the 18^{th}).

Referring back to FIG. 9, in a number of embodiments, method 900 further can include a block 940 of detecting an ad-spend anomaly in the time period by monitoring whether the ad-spend amount is outside the normal range. In some embodiments, after the normal range of ad spends in the time period is predicted in block 930, block 940 can compare the ad-spend amount determined in block 920 with the normal range and determine whether the ad-spend anomaly exists. In certain embodiments, block 940 further can take into account the tolerance for the time period while detecting the ad-spend anomaly.

In a number of embodiments, method 900 further can include a block 950 of determining a pacing-control finding that no pacing-control job is being executed to potentially resolve the ad-spend anomaly. In some embodiments, method 900 also can comprise a pacing-control block (not shown) of performing pacing control to adjust bidding for a remainder of the budget period (e.g., a day, a week, etc.), and block 950 can determine the pacing-control finding based on a status of the pacing-control block (e.g., running, suspended, or stopped, etc.). In many embodiments, the pacing-control block can be similar or identical to block 455 (FIG. 4). In other or similar embodiments, block 950 can determine the pacing-control finding by transmitting an inquiry to a pacing system (e.g., pacing system 304 (FIG. 3), pacing system 814 (FIG. 8), performance bidding system 300 (FIG. 3), or performance bidding system 810 (FIG. 8)) and receiving from the pacing system whether any pacing-control job is being executed.

Still referring to FIG. 9, in a number of embodiments, method 900 further can include a block 960 of transmitting, in real-time through the computer network (e.g., Internet 330 (FIG. 3), Intranet 830 (FIG. 8), or Internet 840 (FIG. 8)), an alert and/or one or more suggested pacing factors to a user (e.g., user 350 (FIG. 3) or user 821 (FIG. 8)) via a user interface executed on a user computer (e.g., user computer 340 (FIG. 3) or user computer 820 (FIG. 8)), in response to the ad-spend anomaly and the pacing-control finding. In some embodiments, when the ad-spend anomaly is detected and when the pacing-control finding is that no pacing-control is being executed, block 960 can notify the user about the anomaly and/or provide the one or more suggested pacing factors to the user by any suitable methods, such as an email, an instant message, a phone call with a prerecorded message, and so forth.

In some embodiments where block 960 transmits the one or more suggested pacing factors to the user when: (a) the ad-spend anomaly is detected and (b) the pacing-control finding indicates that no pacing-control is being executed, block 960 further can include generating the one or more suggested pacing factors based at least in part on one or more of: (i) the ad-spend amount, (ii) the normal range, and/or (iii) user configurations. In some embodiments, block 960 can estimate how severe the ad-spend anomaly is based on the ad-spend amount and the normal range for ad spends and then determine the one or more suggested pacing factors or acts accordingly. For example, in an embodiment, when the anomaly is severe, the one or more suggested pacing factors or acts can include for a pacing control job to temporarily stop or limit bidding for the one or more products on the search engine or on all search engines until after a certain time (e.g., 1 hour, 3 hours, etc.) or until the user has a chance to address the cause of the anomaly. Some exemplary causes of the ad-spend anomaly can include inappropriate bids for certain items, inventory issues, and/or partially missing traffic data from the search engine.

In many embodiments, method 900 further can provide a user interface for the user to set up the user configurations including one or more pacing-factor rules for block 960 to determine the one or more suggested pacing factors. In a few embodiments, method 900 also can include a machine learning model (not shown) to determine the one or more pacing-factor rules. In some embodiments, the machine learning model can be trained based at least in part on the historical ad-spend anomalies, historical pacing factors adopted, and/or the historical results after the pacing-control jobs were executed based on the historical factors.

In a number of embodiments, method 900 further and optionally can include a block 970 of launching a new pacing control job by estimating a predicted total amount consumed for the budget period and adjusting bidding for a remainder of the budget period. In some embodiments, block 970 can launch the new pacing job automatically based at least in part on the ad-spend anomaly, the pacing-control finding, and user configurations and/or a user command received in real-time from the user computer. In certain embodiments, block 970 can include the pacing-control block similar or identical to block 455 (FIG. 4).

In many embodiments, the techniques described herein can provide several technological improvements. In some embodiments, the techniques described herein can provide a bidding platform with controls for multiple objectives. For example, in a number of embodiments, the bidding platform can control for both spending and performance objectives in a selected division and/or subdivision in a manner that equalizes performance within each combination of search engine, ad type, and subdivision. In many embodiments, the techniques described herein can beneficially predict forecasts based on historical information and can adjust based on current information that describes current conditions.

In many embodiments, the techniques described herein can beneficially allow a user (e.g., 350 (FIG. 3) or 821 (FIG. 8)), such as a marketing manager, to set ad spend at a division or subdivision level, and receive a forecast of how the ad spend specified will impact performance for a selected performance objective (e.g., KPI) in the upcoming week. In several embodiments, the performance objective can be selected from a list of possible performance objectives, such as ROAS, CPOAS, CAC, GMV, etc. In various embodiments, the techniques described herein can customize (e.g., optimize) the returns under the performance objective over a time, such as a seven-day rolling model.

In a number of embodiments, the techniques described herein can advantageously allow for automatic pacing of spending to adjust to current conditions, as ad bidding in SEM can involve spending uncertainty. In a number of embodiments, the techniques described herein can be performance automatically without intervention from manual engineering or data scientists.

In various embodiments, the techniques described herein can beneficially detect an ad-spend anomaly in real-time or near-real-time so that the anomaly detected can be timely addressed. In some embodiments, the techniques described herein can automatically determine whether the ad-spend anomaly will likely be resolved without human intervention (e.g., by a pacing-control job being executed), notify the user if the ad-spend anomaly is not insignificant, and/or automatically rectify the ad-spend anomaly by launching a new pacing-control job.

In many embodiments, the techniques described herein can be used continuously at a scale that cannot be handled using manual techniques. For example, the number of PLA ads and textual (keyword) ads at any one time can exceed 100 million, and the web traffic driven by search engines to a website can include approximately 550 million daily impressions.

In a number of embodiments, the techniques described herein can solve a technical problem that arises only within the realm of computer networks, as SEM bidding and the web traffic data related to ad spends does not exist outside the realm of computer networks. Moreover, the techniques described herein can solve a technical problem that cannot be solved outside the context of computer networks. Specifically, the techniques described herein cannot be used outside the context of computer networks, in view of a lack of data, and because the user interface that is part of the techniques described herein would not exist.

Various embodiments can include a system including one or more processors and one or more non-transitory computer-readable media storing computing instructions configured to run on the one more processors and perform certain acts. The acts can include providing a graphical user interface including input fields and output fields. The acts also can include receiving a total allocation amount for a predetermined time period in an allocation amount input field of the input fields of the graphical user interface. The allocation amount input field can constrain the total allocation amount between a lower bound and an upper bound based on a previous allocation amount. The acts additionally can include receiving a performance objective in a performance objective input field of the input fields of the graphical user interface. The performance objective input field can provide a set of options for selection of the performance objective. The acts further can include automatically generating an allocation of the total allocation amount among combinations selected from multiple advertisement types and multiple search engines based at least in part on the total allocation amount and the performance objective according to allocation balancing rules. The acts additionally can include automatically generating one or more performance forecasts based on the allocation. The acts further can include automatically generating a daily allocation forecast across the predetermined time period based on the allocation. The acts additionally can include displaying the daily allocation forecast and the one or more performance forecasts in the output fields of the graphical user interface. The acts further can include, after receiving an approval, automatically bidding for each of the multiple advertisement types at each of the multiple search engines based at least in part on the daily allocation forecast.

A number of embodiments can include a method being implemented via execution of computing instructions configured to run at one or more processors and stored at one or more non-transitory computer-readable media. The method can include providing a graphical user interface including input fields and output fields. The method also can include receiving a total allocation amount for a predetermined time period in an allocation amount input field of the input fields of the graphical user interface. The allocation amount input field can constrain the total allocation amount between a lower bound and an upper bound based on a previous allocation amount. The method additionally can include receiving a performance objective in a performance objective input field of the input fields of the graphical user interface. The performance objective input field can provide a set of options for selection of the performance objective. The method further can include automatically generating an allocation of the total allocation amount among combinations selected from multiple advertisement types and multiple search engines based at least in part on the total allocation amount and the performance objective according to allocation balancing rules. The method additionally can include automatically generating one or more performance forecasts based on the allocation. The method further can include automatically generating a daily allocation forecast across the predetermined time period based on the allocation. The method additionally can include displaying the daily allocation forecast and the one or more performance forecasts in the output fields of the graphical user interface. The method further can include, after receiving an approval, automatically bidding for each of the multiple advertisement types at each of the multiple search engines based at least in part on the daily allocation forecast.

Various embodiments can include a system including one or more processors and one or more non-transitory computer-readable media storing computing instructions configured to run on the one more processors and perform certain acts. The acts can include receiving, through a computer network from a search engine, traffic data associated with one or more products, in a time period of a budget period. The acts also can include determining an ad-spend amount based at least in part on the traffic data. The acts further can include determining a normal range of ad spends for the time period based on a predetermined total allocation amount for the one or more products for the budget period, one or more allocation balancing rules, and/or a spending pattern model. The acts additionally can include detecting an ad-spend anomaly in the time period by monitoring whether the ad-spend amount is outside the normal range. The acts further can include determining a pacing-control finding that no pacing-control job is being executed. The acts also can include transmitting, in real-time through the computer network, an alert to a user via a user interface executed on a user computer, in response to the ad-spend anomaly and the pacing-control finding.

A number of embodiments can include a method being implemented via execution of computing instructions configured to run at one or more processors and stored at one or more non-transitory computer-readable media. The method can include receiving, through a computer network from a search engine, traffic data associated with one or more products, in a time period of a budget period. The method further can include determining an ad-spend amount based at least in part on the traffic data. The method also can include determining a normal range of ad spends for the time period based on a predetermined total allocation amount for the one or more products for the budget period, one or more allocation balancing rules, and a spending pattern model. The method additionally can include detecting an ad-spend anomaly in the time period by monitoring whether the ad-spend amount is outside the normal range. The method further can include determining a pacing-control finding that no pacing-control job is being executed. The method additionally can include transmitting, in real-time through the computer network, an alert to a user via a user interface executed on a user computer, in response to the ad-spend anomaly and the pacing-control finding.

Although bidding platform with controls for multiple objectives and detecting ad-spend anomalies in real-time or near-real-time has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-13 may be modified, and that the foregoing discussion of certain of these embodiments does not necessarily represent a complete description of all possible embodiments. For example, one or more of the procedures, processes, or activities of FIGS. 4 and/or 9 may include different procedures, processes, and/or activities and be performed by many different modules, in many different orders, and/or one or more of the procedures, processes, or activities of FIGS. 4 and/or 9 may include one or more of the procedures, processes, or activities of another different one of FIGS. 4 and/or 9. As another example, the elements, modules, or systems within system 800 in FIG. 8, performance bidding system 300 in FIG. 3, and/or performance bidding system 810 in FIG. 8 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions configured to run on the one or more processors and perform:
receiving, through a computer network from a search engine, traffic data associated with one or more products, in a time period of a budget period;
determining an ad-spend amount based at least in part on the traffic data;
determining a normal range of ad spends for the time period based on a predetermined total allocation amount for the one or more products for the budget period, one or more allocation balancing rules, and a spending pattern model;
detecting an ad-spend anomaly in the time period by monitoring whether the ad-spend amount is outside the normal range;
determining a pacing-control finding that no pacing-control job is being executed; and
transmitting, in real-time through the computer network, an alert to a user via a user interface executed on a user computer, in response to the ad-spend anomaly and the pacing-control finding.

2. The system in claim 1, wherein:
the one or more allocation balancing rules are associated with one or more of:
one or more search engines comprising the search engine;
one or more respective advertisement types for each of the one or more search engines;
respective historical performance for each of the one or more respective advertisement types for each of the one or more search engines; or
respective predicted performance for each of the one or more respective advertisement types for each of the one or more search engines.

3. The system in claim 2, wherein:
the one or more allocation balancing rules comprise allocating the predetermined total allocation amount based on each of the one or more respective advertisement types for each of the one or more search engines to equalize the respective predicted performance for the each of the one or more respective advertisement types for the each of the one or more search engines under a predetermined performance objective.

4. The system in claim 1, wherein:
the spending pattern model comprises an additive time series model trained based at least in part on the traffic data.

5. The system in claim 4, wherein:
the additive time series model comprises a function of one or more of:
an ad-spend trend for the one or more products;
a periodic ad-spend pattern for the one or more products; or
a holiday effect on ad spends for the one or more products.

6. The system in claim 1, wherein:
the computing instructions are further configured to perform:
receiving, from the user computer through the computer network, user configurations associated with an upper boundary and a lower boundary for an acceptable range of ad spends; and
the normal range of ad spends is determined further based on the user configurations.

7. The system in claim 1, wherein the computing instructions are further configured to perform:
generating one or more suggested pacing factors based at least in part on the ad-spend anomaly, the pacing-control finding, and one or more of: the ad-spend amount, the normal range, or user configurations; and
transmitting, in real-time through the computer network, the one or more suggested pacing factors to the user via the user interface.

8. The system in claim 1, wherein the computing instructions are further configured to perform:
launching a new pacing control job based at least in part on the ad-spend anomaly, the pacing-control finding, and at least one of:
user configurations; or
a user command received in real-time by the system through the computer network from the user computer.

9. The system in claim 8, wherein:
the computing instructions are further configured to perform:
generating one or more suggested pacing factors based at least in part on the ad-spend anomaly, the pacing-control finding, and one or more of: the ad-spend amount, the normal range, or the user configurations; and
launching the new pacing control job further comprises adjusting bidding based on the one or more suggested pacing factors.

10. The system in claim 8, wherein:
launching the new pacing control job comprises:
estimating a predicted total amount consumed for the budget period based on actual amounts consumed for the one or more products during a first portion of the budget period and historical amounts consumed for the one or more products, wherein the first portion of the budget period comprises the time period; and
adjusting bidding for a remainder of the budget period based on the predicted total amount consumed for the budget period, the predetermined total allocation amount, and the spending pattern model.

11. A method being implemented via execution of computing instructions configured to run at one or more processors and stored at one or more non-transitory computer-readable media, the method comprising:
receiving, through a computer network from a search engine, traffic data associated with one or more products, in a time period of a budget period;
determining an ad-spend amount based at least in part on the traffic data;
determining a normal range of ad spends for the time period based on a predetermined total allocation amount for the one or more products for the budget period, one or more allocation balancing rules, and a spending pattern model;
detecting an ad-spend anomaly in the time period by monitoring whether the ad-spend amount is outside the normal range;
determining a pacing-control finding that no pacing-control job is being executed; and
transmitting, in real-time through the computer network, an alert to a user via a user interface executed on a user computer, in response to the ad-spend anomaly and the pacing-control finding.

12. The method in claim 11, wherein:
the one or more allocation balancing rules are associated with one or more of:
one or more search engines comprising the search engine;
one or more respective advertisement types for each of the one or more search engines;
respective historical performance for each of the one or more respective advertisement types for each of the one or more search engines; or
respective predicted performance for each of the one or more respective advertisement types for each of the one or more search engines.

13. The method in claim 12, wherein:
the one or more allocation balancing rules comprise allocating the predetermined total allocation amount based on each of the one or more respective advertisement types for each of the one or more search engines to equalize the respective predicted performance for the each of the one or more respective advertisement types for the each of the one or more search engines under a predetermined performance objective.

14. The method in claim 11, wherein:
the spending pattern model comprises an additive time series model trained based at least in part on the traffic data.

15. The method in claim 14, wherein:
the additive time series model comprises a function of one or more of:
an ad-spend trend for the one or more products;
a periodic ad-spend pattern for the one or more products; or
a holiday effect on ad spends for the one or more products.

16. The method in claim 11 further comprising:
receiving, from the user computer through the computer network, user configurations associated with an upper boundary and a lower boundary for an acceptable range of ad spends,
wherein:
the normal range of ad spends is determined further based on the user configurations.

17. The method in claim 11 further comprising:
generating one or more suggested pacing factors based at least in part on the ad-spend anomaly, the pacing-control finding, and one or more of: the ad-spend amount, the normal range, or user configurations; and
transmitting, in real-time through the computer network, the one or more suggested pacing factors to the user via the user interface.

18. The method in claim 11 further comprising:
launching a new pacing control job based at least in part on the ad-spend anomaly, the pacing-control finding, and at least one of:
user configurations; or
a user command received in real-time through the computer network from the user computer.

19. The method in claim 18 further comprising:
generating one or more suggested pacing factors based at least in part on the ad-spend anomaly, the pacing-control finding, and one or more of: the ad-spend amount, the normal range, or the user configurations,
wherein:
launching the new pacing control job further comprises adjusting bidding based on the one or more suggested pacing factors.

20. The method in claim 18, wherein:
launching the new pacing control job further comprises:
estimating a predicted total amount consumed for the budget period based on actual amounts consumed for the one or more products during a first portion of the budget period and historical amounts consumed for the one or more products, wherein the first portion of the budget period comprises the time period; and
adjusting bidding for a remainder of the budget period based on the predicted total amount consumed for the budget period, the predetermined total allocation amount, and the spending pattern model.
